(19) United States
(12) Patent Application Publication
(10) Pub. No.: US 2011/0282951 A1
(43) Pub. Date: Nov. 17, 2011

(54) SYSTEM AND METHOD FOR MANAGING COMMUNICATION

(76) Inventors: Adil Akhtar, Bloomfield Hills, MI (US); Muhammad Sohail Ahmed, Troy, MI (US)

(21) Appl. No.: 13/104,281

(22) Filed: May 10, 2011

Related U.S. Application Data
(60) Provisional application No. 61/333,355, filed on May 11, 2010.

(51) Int. Cl. G06F 15/16

(52) U.S. Cl. 709/206

(57) ABSTRACT

Disclosed herein is a method for communicating healthcare information of a patient using a handheld device including: establishing communication between the handheld device and a management server, sending identifying information for a user of the handheld device to the management server, if the identifying information is authenticated, establishing at least one secured session with the management server, the at least one secured session enabling a user to at least one of: send a message to a user device, wherein the sent message includes at least one of sender information, recipient information and information pertaining to the patient; or receive a message sent from the user device, wherein the received message includes at least one of sender information, recipient information and information pertaining to the patient; wherein the sent and received messages are viewable on the handheld device only during the at least one secured session.

### CROSS REFERENCE TO RELATED APPLICATIONS

This application claims priority to U.S. Provisional Patent Application No. 61/333,355, filed May, 11, 2010, which is hereby incorporated by reference its entirety.

### TECHNICAL FIELD

The present invention relates to in general, a system and method for managing communication and more specifically, a system and method for managing healthcare communication.

### BACKGROUND

Currently, communication between healthcare providers (e.g. doctors, nurses, physician assistants, nurse assistants, administrators, etc.) can be performed, for example, via telephone and/or pagers. In some healthcare facilities, a healthcare provider (e.g. a nurse) may have to make multiple phone calls in order to reach a doctor. In other healthcare facilities, if a healthcare provider needs to contact a doctor and is not able to reach the doctor directly by telephone, the healthcare provider may use the telephone to page the doctor on the doctor's pager. Commonly, the healthcare provider may have to wait until the doctor returns the call. Moreover, once the doctor returns the call, the doctor may also have to wait if the healthcare provider has left the telephone area.

Further, in some instances, communication and coordination between healthcare providers may be lacking. For example, a doctor may provide medical care without being aware of what medical care another doctor has or plans on providing. In some cases, it may be difficult to individually contact each one of these other doctors to ascertain what information a doctor needs or should be aware of before providing medical care/treatment.

### SUMMARY

Embodiments of a method for communicating healthcare information of at least one patient using a handheld device are disclosed herein. In one such embodiment, the method includes establishing communication between the handheld device and a management server and sending identifying information for a user of the handheld device to the management server. If the identifying information is authenticated, the method includes establishing at least one secured session with the management server. The at least one secured session enables a user to at least one of: send a message to a user device, wherein the sent message includes at least one of sender information, recipient information and information pertaining to the at least one patient; or receive a message sent from the user device, wherein the received message includes at least one of sender information, recipient information and information pertaining to the at least one patient. The sent and received messages are viewable on the handheld device only during the at least one secured session.

Embodiments of a method for managing healthcare information of at least one patient are also disclosed herein. In one such embodiment, the method includes establishing communication with at least one handheld device, obtaining identifying information for a user of the at least one handheld device and authenticating the identifying information for the user. If the identifying information is authenticated, the method also includes establishing a secured session to at least one of send communications to or receive communications from the handheld device using at least one processor and generating a message, during the secured session, to at least one of send to the at least one handheld device or receive from the at least one handheld device, wherein the message includes at least one of sender information, recipient information and information pertaining to the at least one patient.

Further, embodiments of a system for managing healthcare information of at least one patient. In one such embodiment, the system includes a communications network and a handheld device in communication with the communications network and operable to send a message, wherein the message includes at least one of sender information, recipient information and information pertaining to the at least one patient. The system also includes at least one processor programmed to execute a process by a management server to obtain identifying information for a user of the at least one handheld device and authenticate the identifying information for the user. If the identifying information is authenticated, the management server establishes at least one secured session to receive the message from the handheld device. The sent message is viewable on the handheld device only during the at least one secured session.

These and other embodiments are described in additional detail hereafter.

### BRIEF DESCRIPTION OF THE DRAWINGS

The description herein makes reference to the accompanying drawings wherein like reference numerals refer to like parts throughout the several views, and wherein:

FIG. 1 is a schematic diagram of a healthcare communication system enabling communication between various user devices by using an application according to one embodiment of the invention;

FIG. 2 is a schematic diagram showing a relationship between entities in the healthcare communication system of FIG. 1;

FIG. 3 is a flow diagram for sending a message using the system of FIG. 1;

FIGS. 4A-G are various user interface screens of the application of the system of FIG. 1.

FIG. 5 is a flow diagram of a process on the application of FIG. 1; and

FIG. 6 s a flow diagram of a process on a management server in the healthcare communication system of FIG. 1.

### DETAILED DESCRIPTION

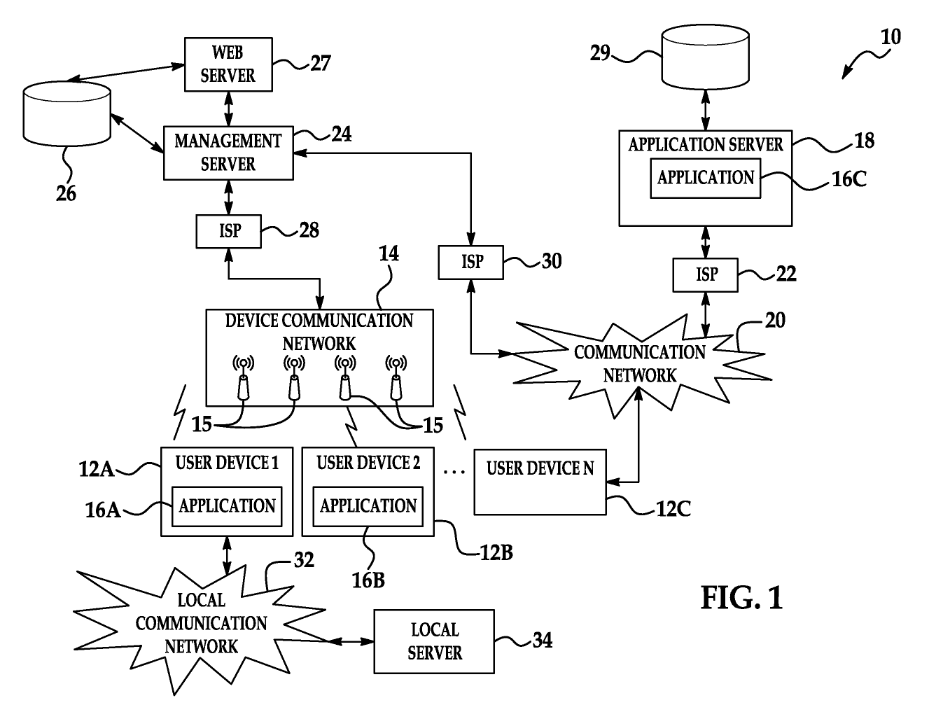

FIG. 1 illustrates a healthcare communication system 10 according to one embodiment which can, for example, enhance communication between various healthcare providers. The system 10 can include, for example, user devices 12A, 12B and 12C. Healthcare providers (e.g. doctors, nurses, pharmacists, residents, physical therapists, physician assistants, nurse assistants, etc.) and/or healthcare staff (administrators, supervisors, managers, etc.) can be equipped with one or more of the user devices 12A-C (hereafter user devices 12 when referenced collectively). Of course, there are other suitable users of user devices 12 in addition to those exemplary users listed above. User devices 12 (i.e. handheld device) can mobile phones, PDAs, smartphones, tablets, notebooks, computers, netbooks or any other suitable communication device. To aid in the reader's understanding of the embodiments, the description hereinafter may refer to user devices 12 as mobile phones. However, reference to mobile phones is merely exemplary and is not to limit the scope of the embodiments.

Each of the user devices 12 can be registered to a device communication network 14 such as WiFi, a cellular provider's network, 3G cellular network, 4G cellular network, mobile SMS/MSM, public communications network or any other suitable device communication network. As illustrated, the user devices 12 are connected to the same device communication network, but of course, one or more of the user devices 12 may be connected to different device communication networks. Each of the user devices 12A-C can execute or run an application 16A-C, respectively, which can permit the users to, for example, communicate with other healthcare providers/staff as will be described in more detail below.

Device communication network 14 can include one or more base stations 15 (e.g. macrocell, femtocell, microcell, picocell, etc.). User devices 12 can communicate with one another through the base station 15 or other transmitting/receiving tower. For example, radio waves can be used to transfer signals between the user devices 12 through the base station 15 Although user devices 12 are shown as communicating through base stations 15, user devices 12 may also communicate through any other suitable manner. For example, in one embodiment, user devices 12 make communicate via satellite.

The applications 16A-C (hereafter applications 16 when referenced collectively) can either be stored on the device (e.g., user device 12A and 12B), or stored on an application server 18 separate from the user devices 12 in which a user device can communicate therewith. For example, as shown, user device 12C does not include the application 16 stored on the device. However, user device 12C can access and run the application 16 through a communication network 20 (e.g., Internet) and an ISP 22. However, access to the application 16 on application server 18 is optional and may be used in addition to or in lieu of storing the application 16 on the user devices. Of course, other suitable methods of accessing and running the application 16 are also available.

Aside from communicating to each other, the user devices 12 can also communicate with a management server 24 via the device communication network 14 and an internet service provider (ISP) 28. Alternatively or in addition to, the user devices 12 can communicate with the server 24 via the communication network 20 and an ISP 30. Although shown as separate providers, in some embodiments, the ISPs 28 and 30 may also be one ISP. The server 24 can also contain a database 26 (or multiple databases) for storing information. For example, in some embodiments, some or all of the communications to and/or from user devices 12 may be stored in the database 26. A database 29 similar to database 26 may also be contained within the application server 18. The database 26 (or database 29 or other database) may be integrated within the server 24 (or other server) or may be separated from the server 24. Server 24 can store communications in or retrieve communications from the database 26. Server 24 and/or server 18 may be hosted by an entity associated with the users of the user devices 12 (e.g. a hospital) or may be hosted by an independent third party.

Server 24 may also be in communication with a web server 27 so that some or all of the processes executed by server 24 may be executed remotely from server 24 over a network (e.g. the Internet). The web server 27, like the server 24 may also be connected to the database for storing or receiving information.

The server 24 can also contain information usable by the applications 16 to facilitate the communication between user devices 16. For example, in one embodiment the server 24 and/or the database 26 can contain information related to the relationship between different entities identified as the system 10. This information can be used to quickly identify the person(s) that should be receiving certain communications. For example, in one embodiment, a user of a user device 12 can choose a specific group of user devices 12 or groups of user devices 12 to send a communication. Accordingly, the user device 12 and/or the database 26 of the server 12 can store the information related to which user devices 12 are a part of a certain group. Once the application 16 has this information, specific communications can be sent to certain user devices of certain groups quickly and with ease. Further, the user transmitting the information will not, for example, have to be concerned with how to reach another user (as may be the case with telephone/pager communications) because the information will be available for viewing when it is sent to the receiving user's device. The user of the user device receiving the communication can then be made aware of certain information regardless of whether the transmitting user had even specifically intended that they receive the information. Thus, using the system 10, information can be circulated and disseminated to increase awareness about any particular topic.

User devices 12 can also communicate with other computer systems and networks other than those previously described. For example, user device 12A is connected with a local server 34 via a local communication network 32 (e.g. LAN, WAN, etc.). The user device 12A can communicate to the local server 34 using, for example, WIFI, or in any other suitable manner. In one embodiment, for example, if a user (e.g. a doctor) is at onsite at a hospital, the doctor may be able to use his user device 12 to access or download patient records or other information stored on the local server 34. The doctor may also be able to upload or change any information located on the local server. The user can then communicate this information to other users 12, as will be discussed in more detail below, as desired or required. For example, if a doctor wishes to discuss an x-ray for a particular patient, the doctor can attach the x-ray and transmit and begin a conversation with other doctors as to what they believe the x-ray shows.

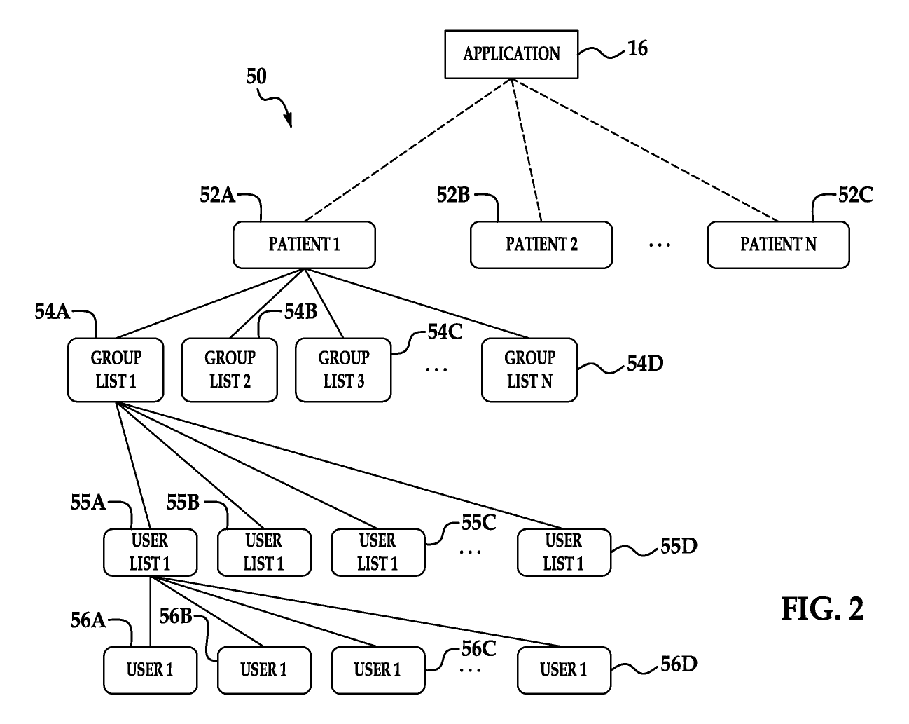

FIG. 2 illustrates an example of a relationship 50 between entities that the application 16 can use to communication information in system 10. In this embodiment, communication of information is centered on a patient 52A, 52B or 52C (hereafter patients 52 when referenced collectively). To ease the reader's understanding of embodiments of the invention, FIG. 2 and the following description will only discuss the relationships associated with patient 52A in detail. However, of course, patients 52B and 52C can be associated with a same or different relationship as patient 52A as desired or required.

As used in the healthcare field, patients 52 can be any person or other being (e.g. animal) that seeks/receives medical care or treatment. For simplicity, the relationship between different entities is only shown and described generally with reference to patient 52A. However, of course, other patients (e.g. patients 52B and 52C) can also have a certain association between entities that may be the same as, similar to or completely different than that shown for patient 52A.

Patient 52A can be assigned to one or more of any suitable number of group lists 54A, 54B, 54C and 54D (hereafter group lists 54 when referenced collectively). Each group 54 can represent a distinct collection of one or more users. For example, group 54A can be a team of physicians, radiologists, staff and/or other healthcare providers attending and/or providing care to patient 52A. In other words, group lists 54 can be based on their relationship to a specific patient. The users in the group lists 54 may or may not be related. For example, the users in the group lists may or may not be part of the same hospital system. Thus, for example, a physician from one hospital facility that is providing care to patient 52A and a staff member of a rehabilitation center that is also providing care to patient 52A may both be included in group list 54A because of their relationship to patient 52A. Group lists 54A may contain other users as desired or required.

Each group list 54 can be can be associated with a user list 55A, 55B, 55C and 55D (hereafter user lists 55 when referenced collectively). Each user list 55 can contain, for example, a group of users of a related professional group. Thus, for example, user list 55A can be a group of oncologists, user list 55B can be a group of nurses and user list 55C can be a group of radiation oncologists. Of course, other user lists are also available and the user lists listed above are merely exemplary. Further, the users do not necessarily have to be part of a hospital setting. For example, in one embodiment, one of the user lists 55 can be a group of social workers or a hospice care facility group. Each of the user lists 55 can contain one or more users 56A, 56B and 56C (hereafter groups 56 when referenced collectively).

Group lists 54 and user lists 55 are merely a feature of this exemplary embodiment. Other embodiments may or may not contain group list 54 and/or user lists 55 and may contain some other association of users 56.

Users 56 can be associated with (i.e. added to) or dissociated from (i.e. deleted from) the user lists 55 or as desired or required. In turn, if a user is associated with or disassociated from one or more of user lists 55, the user may also be moved from a specific group lists so that a user can be associated with or dissociated from patients 52 as desired or required.

Each user 56 can be a healthcare provider and/or part of the healthcare staff as described previously or any other suitable user. Each of the users 56 can have at least one user device 12 (or users). For example, as shown, user 56A can belong to group 54A and 54B, user 56B can belong to groups 54A, 54B, 54C and 54D and user 56C can belong to group 56C. As discussed previously, the server 24 can contain this relationship information so that the application 16 can send communications to the correct users 56 based on which patient 52 and which group 54 are selected, as will be discussed in more detail below.

Further, although the relationship information is described as being stored on the server 24 and/or the storage database 26 separate from the user devices 12, in other embodiments, the relationship information can be stored on the user devices 12 themselves or in any other suitable manner (e.g. web server 27). Of course, the relationship information may be distributed across one or more servers, databases or devices.

Users 56 can use their user devices 12 to communicate with each other via messages such as text messages including short message service (SMS), smart messaging, extended message service (EMS) or multimedia message service (MMS), email, instant messaging, voice messaging or any other suitable messaging protocol. Of course, other types of communication protocols are available and can be used with embodiments of the present invention. To aid in the reader's understanding of the embodiments, the description hereinafter may refer to messages as text messages. However, reference to text messages is merely exemplary and is not to limit the scope of the embodiments.

The messages can contain text information, video information, picture information or audio information pertaining to, for example, a patient. The messages can also contain sender information and/or recipient information. Other information can also be included in the messages.

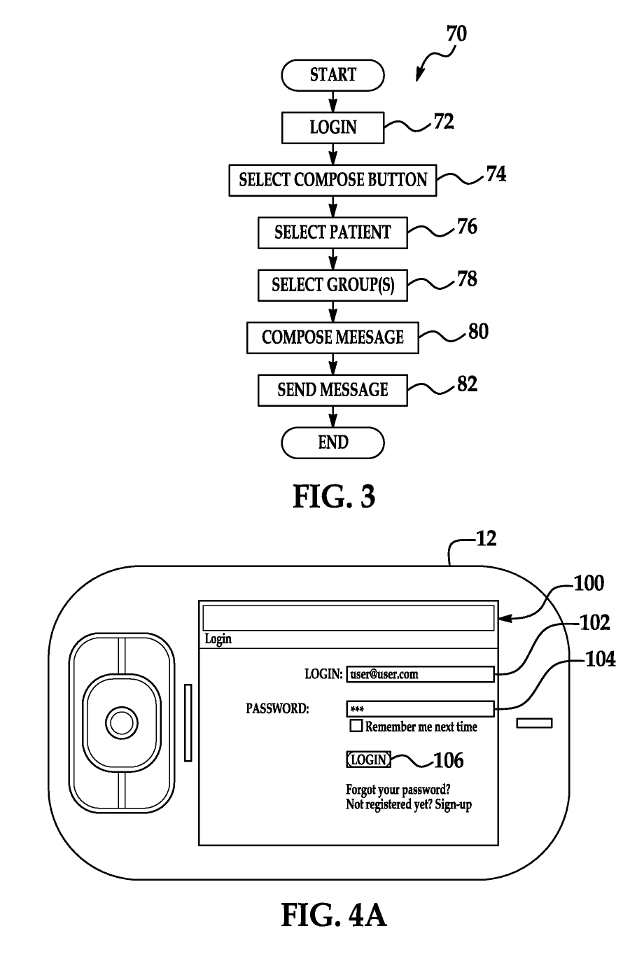

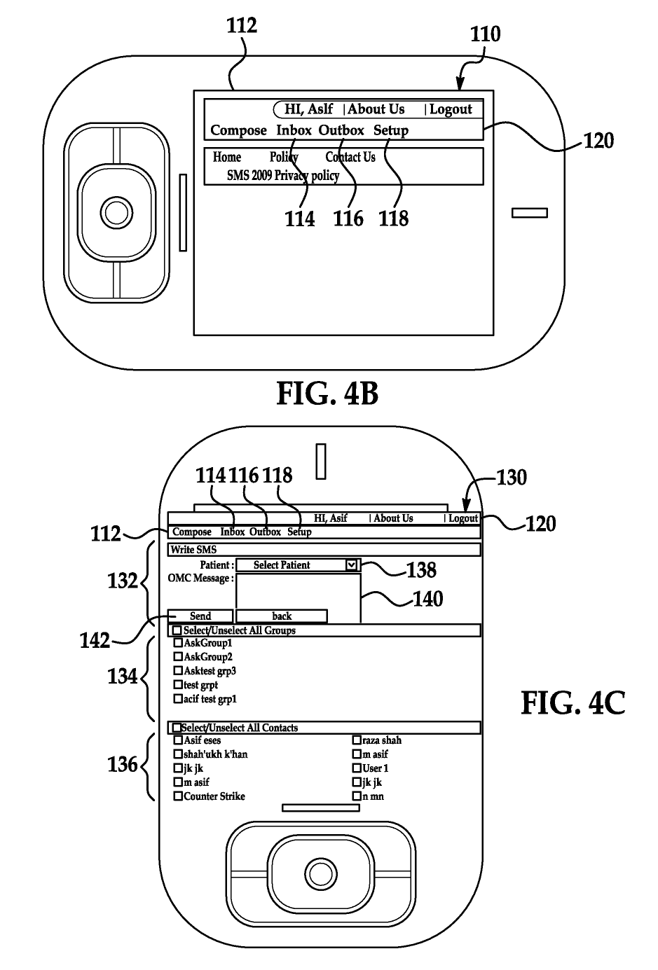

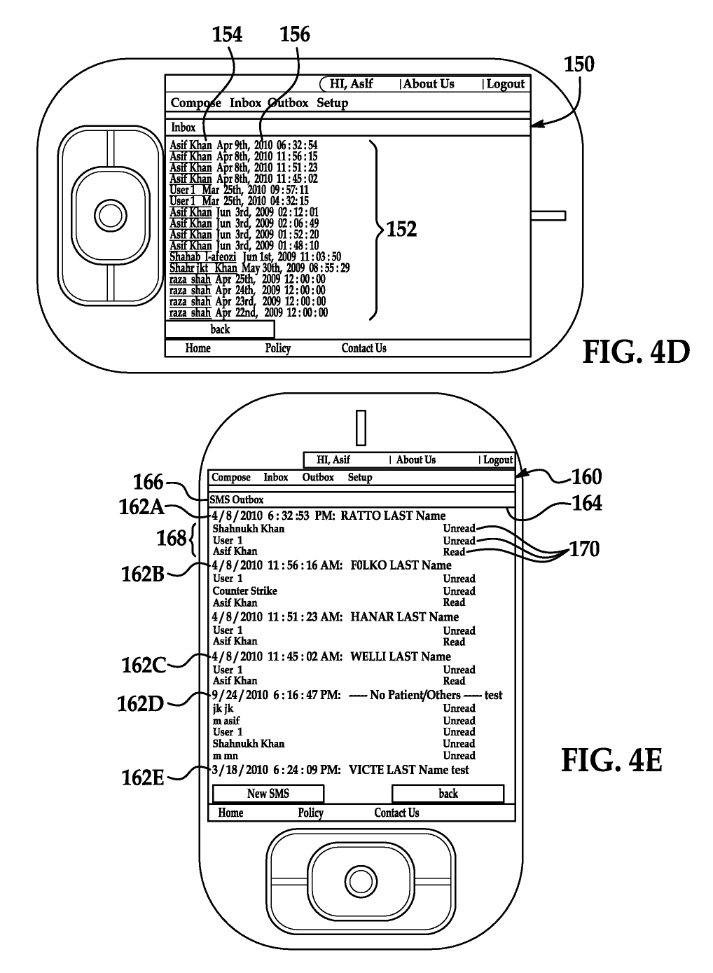

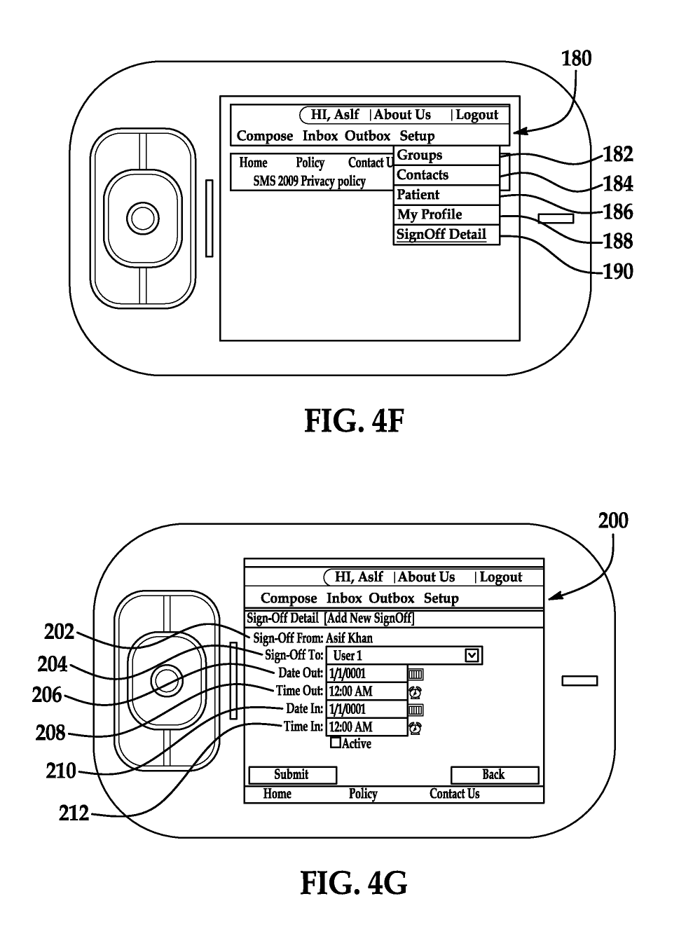

FIG. 3 illustrates a flow diagram 70 of how user 56 can send a message using the application 16 and their user device 12. To send a message, a user can (if they have not already done so) install and/or run the application and login with appropriate login information at step 72. FIG. 4A illustrates an exemplary login user interface screen 100 where the user 56 can perform the login step 72. The user 56 can use, for example, their user device 12 to enter in a login name (e.g. an email address) in a login field 102 and a password in a login field 104.

Once the user 56 has successfully entered in their login information at step 72 and logged in using login button 106, the user can be taken to an exemplary main page user interface screen 110 as shown in FIG. 4B. Main page screen 110 can include a compose button 112 for composing a text message, an inbox button 114 for viewing text messages that have been received, an outbox button 116 for viewing text messages that have been sent (or being prepared to be sent), a setup button 118 for configuring the application 16 and a logout button 120 for logging out of the application.

Returning to FIG. 3, after the user 56 has logged in, as discussed previously with respect to step 72, the user can select the compose button 112 to compose a text message at step 74. Once the user selects the compose button 112, the user 56 can be taken to an exemplary compose text message user interface screen 130 as shown in FIG. 4C. Compose text message screen 130 can include a write message section 132, a group selection section 134 and a contact selection section 136. Once the user is viewing the compose test message screen 120, the user can select a patient 52 from a drop-down list 138 at step 76. The user can then select (or unselect) a group to send the text message to by check one or more groups 54 from the group selection section 134 at step 78. The user 56 may also be to select (or unselect) one or more contacts (that may or not be party of the groups 54) from the contact selection section 136 to send the text message to. The user can then write information that the user desires to send in the write message section 140 at step 80. Alternatively or in addition to, there may be preset messages that the user may select from or message templates that the user can use to compose the text message. Once the user 56 has selected the patient and selected the group(s), the user may use a send button 142 to transmit the text message.

Text messages can be transmitted using the existing resources of the user devices 12 and/or may be utilize the text messaging services of a third party provider such as web services. In the former case, text message may be transmitted through the device communication network 14 whereas in the latter case, the text messages may be transmitted through the communication network 20. Alternatively, system 10 can include applications 16 that use both capabilities. Of course, messages can be transmitted in any other suitable manner as desired or required. For example, text messages can be sent through a desktop or laptop computer or any other suitable device.

Although not shown, other information, such as attachments in the form of medical records, x-rays, demographic information, etc. and may be attached to or sent with the text messages. In other words, embodiments of the present invention are not merely limited to transmitting text data, but can include transmitting pictures, audio, video or any other suitable information.

The user can also select the inbox button 114 to be taken to an exemplary inbox message user interface screen 150 as shown in FIG. 4D. Inbox message screen 150 can include a list of messages 152 that the user 56 has received from other users. Each message can include a name of a sender 154 and a date and/or time 156 that the message was received. As shown, the name of the sender can be selectable such that when the user selects the name, the user can view the message that is sent.

The user can also select the outbox button 116 to be taken to an exemplary inbox message user interface screen 160 as shown in FIG. 4E. Outbox message screen 160 can include a list of messages 162A-E that the user 56 has sent to other users. Each message 162 can include a name of a patient 164 (that the message was sent about) and a date and/or time 166 that the message was sent. Each message can list the name(s) of the intended recipients 168 and a status 170 of whether the message has been read or unread. In this manner, the user 56 sending the message can confirm that the information in the text message has reached certain users of a group 54. As shown, the name of the sender can be selectable such that when the user selects the name, the user can view the message that is sent.

The application 16 can be configured by using the setup button 118. Once the setup button 118 is selected, the user 56 can be presented with a list of options related to configuration of the application 16. For example, the user can select a groups button 182 to add or delete a group 54 (that also may be listed in group selection section 134 of FIG. 4A), to associate or disassociate a group 54 with a patient 52 and/or to associate or disassociate a user 56 with a group 54. The user can also select a contacts button 184 to add or delete a contact 184 (that may be listed in contact selection section 136 of FIG. 4A). The user 56 can also select a patients button 186 to add or delete a patient 52 and/or to associate or disassociate a patient 52 with a group 54. The user can also select a profile button 188 to add, delete or change information related to the particular user 56 using the user device. The user 56 can also select a signoff button 190 that can permit the user 56 to transfer the communications that would ordinarily be sent to its device, to be transferred to another device as will be described in more detail below. Of course, other configuration options are also available other than those illustrated.

When the user selects signoff button 190, the user can be taken to an exemplary signoff user interface screen 200. When a user signs off, communications that would ordinarily be sent to the active user's device can now be routed to another designated user. Signoff screen 200 can include a field 202 to indicate which user (i.e. the active user) is signing off 202, a drop-down box for selecting a user to sign off to (i.e. the designated user), a date 206 and a time 208 indicating when the active user will be signing off and a date 210 and a time 212 indicating when the sign off will end. Once this information has been entered, communications can be automatically routed to the designated user's device. Optionally, the application 16 can send a request to the designated user requesting confirmation that the designated user is able to or desires to accept the signoff.

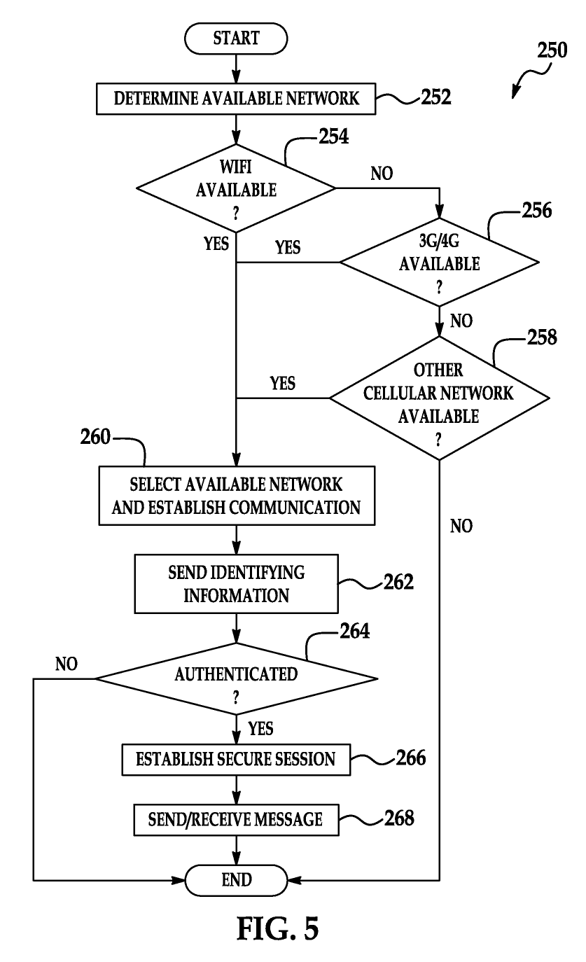

FIG. 5 illustrates a flow diagram of a process 250 on application 16 on a handheld device (e.g. user device 12). Beginning at step 252, application 16 determines the available networks. Control then moves to step 254 to determine if WiFi is available. If WiFi is available, control moves to step 260 to select the available network (in this case, WiFI) and establish communication. Otherwise, if WiFi is not available, control moves to step 256 to determine whether a 3G or 4G cellular network is available. Generally, the handheld device will be equipped with either 3G or 4G functionality although in some embodiments, the handheld device may be equipped with both. If a 3G or 4G cellular network is available, control moves to step 260 to select the 3G or 4G cellular network and establish communication. If a 3G or 4G cellular network is not available, control moves to step 258 to determine if any other cellular network is available (e.g. mobile SMS/MSM). If another cellular network is available, control moves to step 260 to select the other cellular network and establish communication. Of course, other device communication networks as discussed previously (e.g. device communication network 14).

Once communication has been established, control moves to send identifying information to the management server 24. Identifying information can include, as discussed previously in connection with FIG. 4A, a login name and a password. Control then moves to step 264 to determine whether the identifying information is authenticated. Authentication can take place at, for example, the management server 24. If the identifying information is not authenticated, the process ends. Management server may optionally send an error message to the handheld device.

If the identifying information is authenticated, a secure session can be established at step 266. The secure session permits information control between the handheld device and the management server 24 via encryption or other security protocol means. Accordingly, the information can be safeguarded and be compliant with any guidelines for handling of health information (e.g. HIPAA). Once the secure session has been established, messages may be sent and received by the handheld device 268. Notifications may also be sent to the handheld device when there is a message available for retrieval. Once any desired messages have been sent or received, the process ends either via timeout (e.g. five minutes) or user sign-off.

The messages sent/received by the handheld device 268 are not viewable by the handheld device unless there is a secured session in process. In other words, if the user of the handheld device has not performed authentication of their handheld device using their identifying information, the user will not be able to view, send or retrieve any messages on their device. Accordingly, for example, should the handheld device be misplaced, stolen or lost, another person will not be able to access any health related information of any patient.

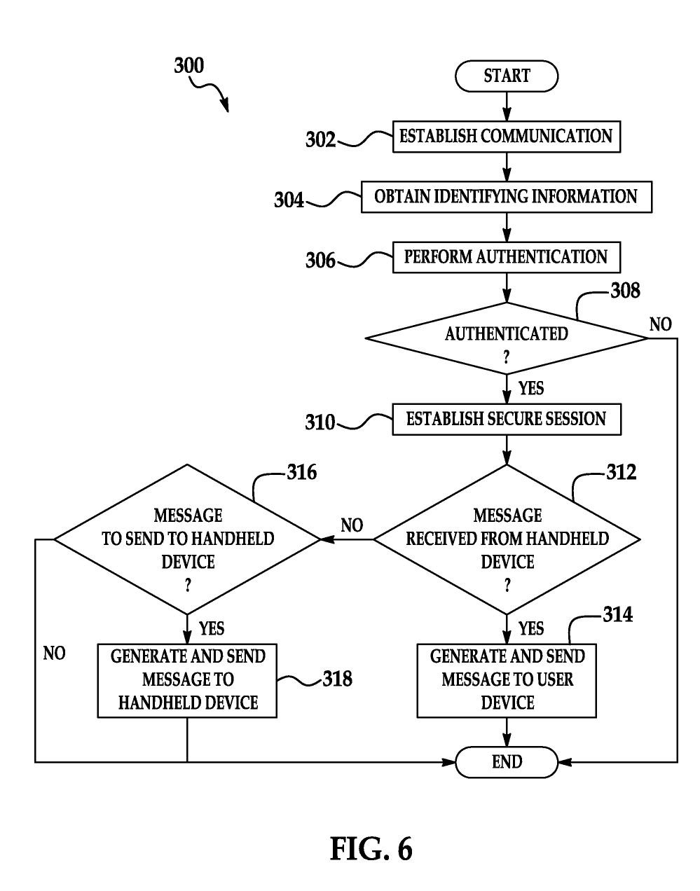

FIG. 6 illustrates a flow diagram of a process 300 on management server 24. Beginning at step 302, communication can be established with the handheld device. The communication can be established when, for example, the user of the handheld device requests access to the server (i.e in order to send/receive a message). Once communication has been established, identifying information may be obtained from the handheld device. This identifying information is discussed previously with step 262 of FIG. 5. At step 306, authentication can be performed, which can include, for example, determining whether the login name and password are correct. The information used in the authentication process can be stored on the management server, or alternatively at another location (e.g. database 26). Control then moves to step 308 to determine if the identifying information has been authenticated.

If the identifying information is not authenticated, the process ends. If the identifying information is authenticated, a secure session can be established at step 310 similar to that discussed previously in connection with step 266 of FIG. 5. Control then moves to step 312 to determine if a message has been received from the handheld device. If a message has been received from the handheld device, control moves to step 314 to generate and send a message to a user device (different than the handheld device sending the message).

Generating and sending the message can include any action desired or required to format the message according to a protocol that is secure and is compatible with the user device receiving the message. The user device receiving the message can be a handheld device (e.g. mobile phone) or a computer (e.g. laptop, desktop, etc.). Thus, for example, the management server 24 can encrypt the message so that it is secure when sending it to the user device. Additionally, the management server can optionally store the message in, for example, database 29 or another database (e.g. database 26). The management server can also, for example, use web server 27 to format the message in a manner compatible with the user device.

If a message has not been received from the handheld device, control moves to step 316 to determine if there is a message to send to the handheld device. If there is no message to send to the handheld device, the process ends. Otherwise, if there is a message to send to the handheld device, the management server can generate and send the message to the handheld device.

In the context of sending a message, the step(s) of generating and sending the message to the handheld device can involve retrieving the message from the database 29 and transmitting it to the handheld device. This message may have been stored in the database 29 similar to that discussed at step 312 or may have been sent from another device (e.g. a computer). The management server 24 may, if necessary, perform any action desired or required to format the message according to a protocol that is secure and is compatible with the handheld device.

User devices 12 (including the handheld device) contain a memory (e.g. RAM, ROM, etc.) and a processor configured to execute instructions on the memory. User devices 12 can be realized in hardware, software, or any combination thereof including, for example, IP cores, ASICS, programmable logic arrays, optical processors, programmable logic controllers, microcode, firmware, microcontrollers, servers, microprocessors, digital signal processors or any other suitable circuit or other information processing device now existing or hereafter developed.

Server 24 contains a memory (e.g. RAM, ROM, etc.) and a processor configured to execute instructions on the memory. Server 24 can be realized in hardware, software, or any combination thereof including, for example, IP cores, ASICS, programmable logic arrays, optical processors, molecular processors, quantum processors, programmable logic controllers, microcode, firmware, microcontrollers, servers, microprocessors, digital signal processors or any other suitable circuit or other information processing device now existing or hereafter developed.

Although not shown, the functionality of the embodiments disclosed herein can also be accessed through a personal computer or other device. Thus, for example, if a doctor is at a hospital and wishes to send a message to one of the user devices 12, the doctor may access a website or program that provides similar functionality to that described above. In other words, for example, the doctor may be able to compose a message, view inbox messages, view outbox messages, perform signoff and configure his system through a device that is separate from the user device 12.

Although the embodiments described herein have referenced the healthcare field, the embodiments of the invention are not to be limited as such. For example, embodiments of the present invention can be use in industrial factories, retail stores or any other suitable field or context.

Further, for example, the messaging system disclosed herein can be used to replace existing communication systems (e.g. email) between individuals. Accordingly, the user devices 12 can function as all-in-one devices that provide a user with capabilities necessary to communicate with other users.

While the invention has been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method for communicating healthcare information of at least one patient using a handheld device, comprising:
establishing communication between the handheld device and a management server;
sending identifying information for a user of the handheld device to the management server;
if the identifying information is authenticated, establishing at least one secured session with the management server, the at least one secured session enabling a user to at least one of:
send a message to a user device, wherein the sent message includes at least one of sender information, recipient information and information pertaining to the at least one patient; or
receive a message sent from the user device, wherein the received message includes at least one of sender information, recipient information and information pertaining to the at least one patient;
wherein the sent and received messages are viewable on the handheld device only during the at least one secured session.

2. The method of claim 1, wherein establishing communication further comprises:
determining one or more available networks; and
selecting, from among the one or more available networks, a communication network to communicate from the at least one handheld device.

3. The method of claim 2, wherein the one or more available networks includes at least one of WiFi network, mobile SMS/MSM, 3G cellular network or 4G cellular network.

4. The method of claim 3, further comprising:
if the WiFi network is included in the one or more available networks, selecting the WiFi network as the communication network.

5. The method of claim 1, further comprising:
receiving a notification indicative of the received message being available for retrieval.

6. The method of claim 1, wherein the user device is at least one of a handheld device and a computer.

7. The method of claim 1, wherein the message includes at least one of text content, picture content and audio content.

8. The method of claim 1, wherein the handheld device is at least one of a mobile phone, a PDA, a smartphone, a netbook or a tablet.

9. The method of claim 1, wherein enabling the user to send the message further comprises:
receiving input from the user, the input including at least one of the sender information, recipient information and information pertaining to the at least one patient;
generating the sent message based on the received input; and
sending the message to the management server.

10. A method for managing healthcare information of at least one patient, comprising:
establishing communication with at least one handheld device;
obtaining identifying information for a user of the at least one handheld device;
authenticating the identifying information for the user; and
if the identifying information is authenticated:
establishing a secured session to at least one of send communications to or receive communications from the handheld device using at least one processor; and
generating a message, during the secured session, to at least one of send to the at least one handheld device or receive from the at least one handheld device, wherein the message includes at least one of sender information, recipient information and information pertaining to the at least one patient.

11. The method of claim 10, wherein if the secured session is established to send communications to the handheld device, generating the message further comprises:
obtaining the message from a user device different than the at least one handheld device; and
securing the message using an encryption protocol and storing the secured message in a database.

12. The method of claim 11, further comprising:
sending a notification to the at least one handheld device, the notification indicative of the secured message being available for retrieval.

13. The method of claim 12, further comprising:
retrieving the secured message from the database; and
sending the secured message to the at least one handheld device.

14. The method of claim 10, wherein the user device is at least one of a handheld device and a computer.

15. The method of claim 10, wherein if the secured session is established to receive communications from the handheld device, generating the message further comprises:
obtaining the message from the at least one handheld device;
determining a user device associated with the recipient information; and
formatting the message in accordance with a communications protocol compatible with the user device.

16. The method of claim 15, further comprising:
securing the formatted message using an encryption protocol and storing the secured message in a database; and
sending the secured message to the user device.

17. The method of claim 10, wherein the message includes at least one of text content, picture content and audio content.

18. A system for managing healthcare information of at least one patient, comprising:
a communications network;
a handheld device in communication with the communications network and operable to send a message, wherein the message includes at least one of sender information, recipient information and information pertaining to the at least one patient; and
at least one processor programmed to execute a process by a management server to:
obtain identifying information for a user of the at least one handheld device;
authenticate the identifying information for the user; and
if the identifying information is authenticated, establish at least one secured session to receive the message from the handheld device;
wherein the sent message is viewable on the handheld device only during the at least one secured session.

19. The method of claim 18, wherein the handheld device is configured to:
determine one or more available networks; and
selecting, from among the one or more available networks, the communication network to communicate from the at least one handheld device.

20. The method of claim 19, wherein the one or more available networks includes at least one of WiFi network, 3G cellular network or 4G cellular network.
